(19) United States
(12) Patent Application Publication
(10) Pub. No.: US 2026/0118736 A1
(43) Pub. Date: Apr. 30, 2026

(54) CAMERA MODULE

(71) Applicant: Samsung Electro-Mechanics Co., Ltd., Suwon-si (KR)

(72) Inventors: Jaeki EOM, Suwon-si (KR); Youjin JEONG, Suwon-si (KR)

(73) Assignee: Samsung Electro-Mechanics Co., Ltd., Suwon-si (KR)

(21) Appl. No.: 19/073,307

(22) Filed: Mar. 7, 2025

(30) Foreign Application Priority Data
Oct. 30, 2024 (KR) 10-2024-0150370

(51) Int. Cl. G03B 13/36; G02B 7/09; G02B 13/00; G03B 5/00; H04N 23/55

(52) U.S. Cl. CPC G03B 13/36; G02B 7/09; G02B 13/0065; G03B 5/00; H04N 23/55; G03B 2205/0069

(57) ABSTRACT

A camera module includes a lens module including at least one lens; an optical waveguide member configured to propagate light incident from the lens module in a first direction to a second direction through total internal reflection, and reflect the light propagated in the second direction back to the first direction, the optical waveguide member including a plurality of first split reflective surfaces, a waveguide part, and a plurality of second split reflective surfaces; and an image sensor module configured to convert the light reflected in the first direction by the optical waveguide member into an electrical signal, wherein the plurality of first split reflective surfaces is inclined to reflect light incident from the lens module, the waveguide part propagates the light reflected, and the plurality of second split reflective surfaces is inclined to reflect the light propagated by the waveguide part.

### CROSS-REFERENCE TO RELATED APPLICATIONS

This application claims the benefit under 35 USC 119(a) of Korean Patent Application No. 10-2024-0150370 filed on Oct. 30, 2024, in the Korean Intellectual Property Office, the entire disclosure of which is incorporated herein by reference for all purposes.

### BACKGROUND

### 1. Field

The following description relates to a camera module.

### 2. Description of the Related Art

With the significant development of information, communication, and semiconductor technologies, the supply and use of electronic devices have rapidly increased. Cameras are currently used in portable electronic devices such as smartphones, tablet PCs, and laptop computers.

Smartphone cameras initially used low-resolution sensors, and there was simply a competition in magnifications. However, the aspect of technological competition is shifting towards overcoming the differences in quality levels with wide cameras.

In response to this, high-resolution image sensors are being employed, and as a result, the size of the image sensors is increasing, thereby increasing the overall size of the camera module. In particular, in the case of a camera module with a folded zoom function, which refracts vertically incoming light in a horizontal direction to increase the focal length, there is a problem that it does not meet the required height of the camera module when applying high-resolution image sensors.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a lens module including at least one lens; an optical waveguide member, disposed below the lens module, configured to propagate light incident from the lens module in a first direction to a second direction through total internal reflection, and reflect the light propagated in the second direction back to the first direction, the optical waveguide member including a plurality of first split reflective surfaces, a waveguide part, and a plurality of second split reflective surfaces; and an image sensor module, disposed above the optical waveguide member and spaced apart from the lens module, configured to convert the light reflected in the first direction by the optical waveguide member into an electrical signal, wherein the plurality of first split reflective surfaces is inclined to reflect light incident from the lens module in the first direction below the lens module, the waveguide part propagates the light reflected from the plurality of first split reflective surfaces in the second direction through total internal reflection, and the plurality of second split reflective surfaces is inclined to reflect the light propagated by the waveguide part in the first direction below the image sensor module.

The plurality of first split reflective surfaces may be inclined such that the incident angle of light incident from the lens module in the first direction is greater than a critical angle of the optical waveguide member. The plurality of second split reflective surfaces may be inclined such that the incident angle of the light propagated by the waveguide part is greater than the critical angle of the optical waveguide member.

The plurality of first split reflective surfaces and the plurality of second split reflective surfaces may be formed to be inclined at an angle of 5 degrees or more and 45 degrees or less with respect to a plane perpendicular to the first direction.

The plurality of first split reflective surfaces and the plurality of second split reflective surfaces may be formed to be inclined at an angle of 15 degrees or more and 30 degrees or less with respect to the plane perpendicular to the first direction.

The plurality of first split reflective surfaces and the plurality of second split reflective surfaces may each have 2 to 5 reflective surfaces.

The plurality of first split reflective surfaces and the plurality of second split reflective surfaces may include a metal coating layer.

The optical waveguide member may be formed by a prism made of plastic or glass material.

An imaging surface of the image sensor module may be disposed to face an upper surface of the optical waveguide member.

The lens module may include an autofocus (AF)/optical image stabilization (OIS) driver which configured to perform AF and OIS functions.

The image sensor module may include an AF/OIS driver configured to perform autofocus and optical image stabilization functions.

The lens module may include an AF driver configured to perform an autofocus function, and the image sensor module may include an OIS driver configured to perform an optical image stabilization function.

In another general aspect, a camera module includes a lens module including at least one lens; an optical waveguide module, disposed below the lens module, configured to propagate light incident from the lens module in a first direction to a second direction through total internal reflection, and reflect the light propagated in the second direction back to the first direction; and an image sensor module, disposed above the optical waveguide module and spaced apart from the lens module, configured to convert the light reflected in the first direction by the optical waveguide module into an electrical signal. The optical waveguide module includes a first mirror plate, a plurality of first split reflection arrays disposed obliquely on one surface of the first mirror plate under the lens module to reflect light incident in the first direction from the lens module, a second mirror plate disposed above the first mirror plate to form an optical waveguide between the first mirror plate and the second mirror plate, and a plurality of second split reflection arrays disposed obliquely on the one surface of the first mirror plate under the image sensor so that light propagated by the optical waveguide is reflected in the first direction.

The plurality of first split reflection arrays and the plurality of second split reflection arrays may be disposed to be inclined at an angle between 15 degrees and 30 degrees with respect to the first mirror plate.

The plurality of first split reflection arrays and the plurality of second split reflection arrays may each have 2 to 5 reflective surfaces.

An imaging surface of the image sensor module may be disposed to face the optical waveguide module.

Other features and aspects will be apparent from the following detailed description, the drawings, and the claims.

### BRIEF DESCRIPTION OF DRAWINGS

FIG. 1 is a perspective view illustrating the exterior of a camera module according to an embodiment.

FIG. 2 is an exploded perspective view illustrating the camera module shown in FIG. 1.

FIG. 3 is a cross-sectional view of a portion of the camera module shown in FIG. 1.

FIG. 4 is an illustration showing an optical waveguide member in the camera module shown in FIG. 1.

FIG. 5 is a schematic illustration of a light path of the camera module shown in FIG. 1.

FIG. 6 is a schematic illustration of a camera module according to another embodiment.

FIG. 7 is a schematic illustration of a camera module according to another embodiment.

FIG. 8 is a schematic illustration of a camera module according to another embodiment.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

Hereinafter, the optical axis may be set as the central axis of the lens perpendicular to the lens surface, and the optical axis direction (Z-axis direction) means the direction parallel to the central axis. In the drawings, the optical axis is set as the Z-axis, and the X-axis and Y-axis are set in the direction perpendicular to the optical axis. In this case, the X-axis and the Y-axis are perpendicular to each other, and the X-Y plane formed by the X-axis and the Y-axis becomes a plane perpendicular to the optical axis.

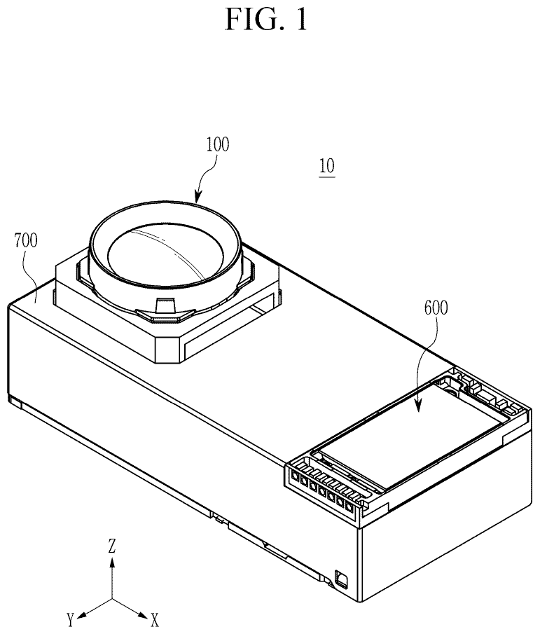

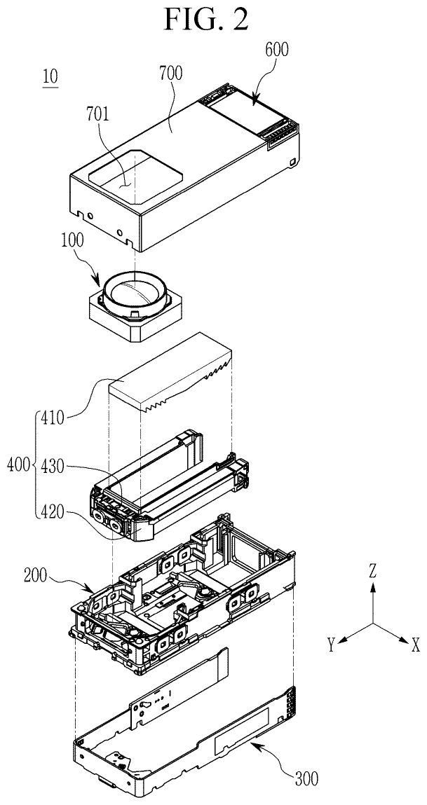

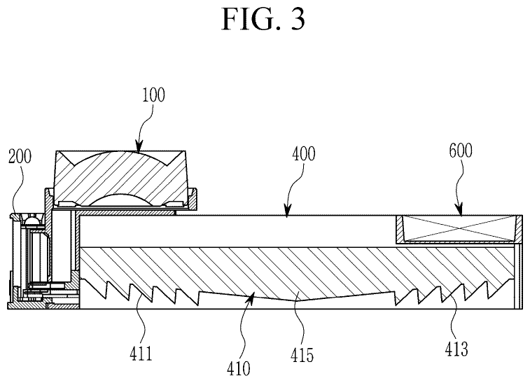

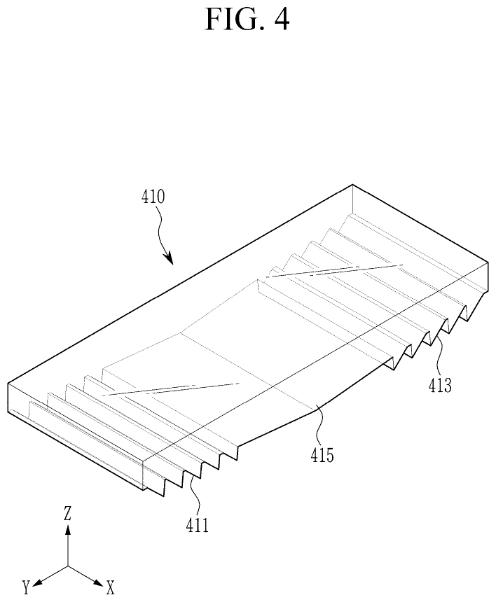

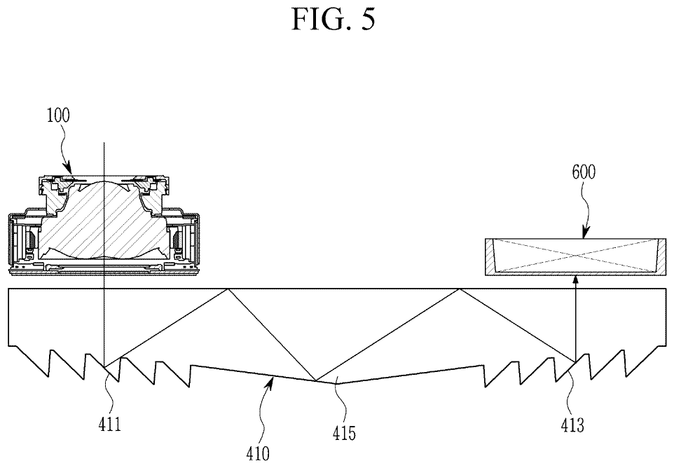

FIG. 1 is a perspective view illustrating the exterior of a camera module according to an embodiment. FIG. 2 is an exploded perspective view illustrating the camera module shown in FIG. 1. FIG. 3 is a cross-sectional view of a portion of the camera module shown in FIG. 1. FIG. 4 is an illustration showing an optical waveguide member in the camera module shown in FIG. 1. FIG. 5 is a schematic illustration of a light path of the camera module shown in FIG. 1.

Referring to FIGS. 1 to 4, a camera module 10 according to the present embodiment includes a lens module 100, a housing 200, a circuit board 300 that surrounds the housing 200 from the outside, a folded module 400 accommodated in the internal space of the housing 200, and an image sensor module 600.

The camera module 10 may include a cover 700 that partially surrounds the housing 200. The cover 700 may prevent components accommodated inside the housing 200 from being separated from the housing 200. For example, the housing 200 may have a box shape with an upper part open. That is, the housing 200 may have a bottom portion having a quadrangular shape on a plane and a side portion. The cover 700 may have a box shape with an open bottom so that the upper part of the housing 200 may be closed. The folded module 400 may be disposed in a space surrounded by the housing 200 and the cover 700.

The cover 700 may include a material capable of shielding electromagnetic waves. The cover 700 may block or minimize electromagnetic waves generated inside the camera module 10 from escaping outside the camera module 10 and electromagnetic waves outside the camera module 10 from entering inside the camera module 10. For example, the cover 700 may be a shield can.

The cover 700 may have an opening 701. A portion of the lens module 100 may protrude to the outside through the opening 701 formed on the cover 700. External light may enter through the opening 701 of the cover. A lens accommodated in the lens module 100 may be disposed in the direction in which light travels.

The lens module 100 may be partially covered by the cover 700. The lens module 100 may partially protrude to the outside through the opening 701 of the cover 700. The lens module 100 may include a lens barrel and a lens holder. The lens barrel may have a cylindrical shape with an internal space formed therein and may accommodate a plurality of lenses within the internal space. The plurality of lenses may be arranged along the optical axis direction (a first direction, Z-axis direction). Individual lenses included in the plurality of lenses may have unique optical characteristics. For example, individual lenses included in the plurality of lenses may have different refractive indices. The lens barrel may at least partially protrude to the outside through the first opening 701 of the cover 700.

The lens holder may accommodate the lens barrel. The lens holder may at least partially contact the side portion of the housing 200. The lens holder may be accommodated at least partially in the interior space of the housing 200. The lens holder may be at least partially covered by the cover 700.

The lens module 100 may cover a portion of the folded module 400. The lens module 100 may be coupled with the housing 200 by contacting the outer side of the side portion of the housing 200. A light incident in the first direction (Z-axis direction) from the outside of the lens module 100 may pass through the lens module 100 and move to the folded module 400.

The lens module 100 may include at least a portion of an AF (Autofocus) driver. For example, the lens module 100 may include an AF magnet. The lens module 100 may move along the optical axis by electromagnetic interaction between the AF magnet and an AF coil mounted on the circuit board 300. The lens module 100 may include a shutter (not shown) that blocks light from entering the upper part.

The folded module 400 may include an optical waveguide member 410 that changes the path of light, a carrier 420, and a rotating holder 430 housed within the carrier 420.

The optical waveguide member 410 may be disposed below the lens module 100 and may reflect and propagate light that is incident from the lens module 100 in the first direction (Z-axis direction). The optical waveguide member 410 may propagate light incident from the lens module 100 in the first direction through total internal reflection in the second direction (Y-axis direction), and may reflect the light propagated in the second direction back to the first direction. The light whose path has been altered by the optical waveguide member 410 may reach the image sensor module 600.

The optical waveguide member 410 may include a plurality of first split reflective surfaces 411 disposed below the lens module 100, a plurality of second split reflective surfaces 413 disposed below the image sensor module 600, and a waveguide part 415 formed between the plurality of first split reflective surfaces 411 and the plurality of second split reflective surfaces 413. The optical waveguide member 410 may be made of a material that reflects or propagates light, and it may be plastic or glass. For example, the optical waveguide member 410 may be a prism made of plastic or glass material.

The first split reflection surfaces 411 may be formed with a plurality of reflection surfaces inclined so that light incident from the lens module 100 in the first direction is split and reflected. The angle of inclination of the first split reflection surfaces 411 may be a total internal reflection angle at which light incident from the lens module 100 into the optical waveguide member 410 is totally internally reflected at the first split reflection surfaces 411. Here, the reference for the angle of inclination of the first split reflection surfaces 411 may be based on the plane (X-Y plane) perpendicular to the first direction.

The first split reflective surfaces 411 may be inclined so that the angle of incidence of light entering from the lens module 100 in the first direction is greater than the critical angle of the optical waveguide member 410. For example, if the refractive index of the optical waveguide member 410 is 2.0, the critical angle of the optical waveguide member 410 is 30 degrees, and thus, the first split reflective surfaces 411 may be formed so that the plural reflective surfaces have an inclination of more than 30 degrees. As the refractive index of the optical waveguide member 410 increases, the critical angle decreases, so the inclination angle of the first split reflective surfaces 411 may be reduced when using the optical waveguide member 410 with a high refractive index. The inclination angle of the first split reflective surfaces 411 may be at least 5 degrees so that the light reflected from the first split reflective surfaces 411 may reach the upper surface of the waveguide part 415. It may be desirable that the inclination angle of the first split reflective surfaces 411 be at least 15 degrees so that the light reflected from the outermost reflective surface of the first split reflective surfaces 411 smoothly reaches the upper surface of the waveguide part 415.

The first split reflective surfaces 411 may be inclined at an angle not exceeding the maximum angle at which light incident on the optical waveguide member 410 may be directed toward the image sensor module 600. For light incident in the first direction to propagate in the second direction perpendicular to the first direction, the sum of the angle of incidence and the angle of reflection must be 90 degrees or less. Therefore, the inclination angle of the first split reflective surfaces 411 may be 45 degrees or less, and the closer the inclination angle of the first split reflective surfaces 411 is to 45 degrees, the closer the light reflected from the first split reflective surfaces 411 gets to the lower surface of the optical waveguide member 410, potentially increasing the path length to reach the upper surface of the optical waveguide member 410. Therefore, it may be desirable for the inclination angle of the first split reflective surfaces 411 to be 30 degrees or less to facilitate smooth multiple reflections in the waveguide part 415.

Therefore, the inclination angle of the first split reflective surfaces 411 may be 5 degrees or more and 45 degrees or less. For example, it may be 15 degrees or more and 30 degrees or less.

The waveguide part 415 may be disposed between the lens module 100 and the image sensor module 600. The light reflected from the first split reflective surfaces 411 may propagate in the second direction (Y-axis direction) through total internal reflection within the waveguide part 415. The waveguide part 415 may totally reflect the light reflected from the first split reflective surfaces 411 from the upper surface to the lower surface of the waveguide part 415 and may totally reflect the light totally reflected from the upper surface to the lower surface of the waveguide part 415 back from the lower surface to the upper surface of the waveguide part 415. In this way, the waveguide part 415 may propagate the light reflected from the first split reflective surfaces 411 in the second direction (Y-axis direction) through repeated total internal reflection. To extend the length of the light in the second direction (Y-axis direction) that is totally reflected at one time, the lower or upper surface of the waveguide part 415 may be formed to be inclined.

The second split reflection surfaces 413 may be formed with multiple reflective surfaces inclined so that light propagated by the waveguide part 415 may be split and reflected. The inclination angle of the second split reflection surfaces 413 may be the angle at which the light propagated from the waveguide part 415 may be totally reflected on the second split reflection surfaces 413. Here, the reference for the inclination angle of the second split reflection surfaces 413 may be based on a plane (x-y plane) perpendicular to the first direction.

The second split reflection surfaces 413 may be inclined such that the angle of incidence of light propagated from the waveguide part 415 is greater than the critical angle of the optical waveguide member 410. For example, if the refractive index of the optical waveguide member 410 is 2.0, the critical angle of the optical waveguide member 410 is 30 degrees, and thus the second split reflection surfaces 413 may be formed so that multiple reflection surfaces have an inclination angle of more than 30 degrees. As the refractive index of the optical waveguide member 410 increases, the critical angle decreases, so the greater the refractive index of the optical waveguide member 410 used, the smaller the inclination angle of the second split reflection surfaces 413 may be.

The inclination angle of the second split reflection surfaces 413 may be between 5 degrees and 45 degrees. For example, the inclination angle may be between 15 degrees and 30 degrees, so that all light reaching the second split reflection surfaces 413 in the waveguide part 415 may be totally internally reflected and the light reflected from the second split reflection surfaces 413 may reach the image sensor module 600. If the inclination angle of the second split reflection surfaces 413 is less than 5 degrees, the light may not be totally internally reflected at the second split reflection surfaces 413, and if it exceeds 45 degrees, the light reflected from the second split reflection surfaces 413 may not reach the image sensor module 600.

In order to achieve the thinning of the camera module 10, the number of reflective surfaces of the first split reflective surfaces 411 and the second split reflective surfaces 413 may be two or more. As the number of reflective surfaces of the first split reflective surfaces 411 and the second split reflective surfaces 413 increases, the thinning effect of the camera module 10 may be enhanced. However, as the number of reflective surfaces increases, the likelihood of diffraction interference caused by the reflective surface grid also rises, so it may be desirable to have five or fewer to prevent this.

A metal coating layer may be formed on the reflective surfaces of the first split reflective surfaces 411 and the second split reflective surfaces 413 to facilitate total internal reflection of light.

The optical waveguide member 410 may be coupled to the rotating holder 430. For example, the carrier 420 may be supported by a ball group (not shown) located between the bottom part of the housing 200 and the carrier 420, allowing it to rotate about a first axis parallel to the first direction (Z-axis direction). In addition, the rotating holder 430 may be supported by a second ball group (not shown) located between the carrier 420 and the rotating holder 430, allowing it to rotate about a second axis parallel to the second direction (X-axis direction). As the carrier 420 or the rotating holder 430 rotates, the optical waveguide member 410 housed in the rotating holder 430 can also rotate.

The folded module 400 may include at least a part of the OIS driver. For example, the folded module 400 may include an OIS magnet. Through electromagnetic interaction between the OIS magnet and the OIS coil mounted on the circuit board 300, the folded module 400 can rotate around an axis perpendicular to the optical axis.

The image sensor module 600 may be disposed spaced apart from the lens module 100 on top of the optical waveguide member 410. Part of the image sensor module 600 may be exposed on one side of the cover 700.

The image sensor module 600 includes a sensor substrate and an image sensor disposed on the sensor substrate. The image sensor is a device that receives the incident light incident from the folded module 400 and converts it into an electric signal, and may be either a charge coupled device (CCD) or a complementary metal oxide semiconductor (CMOS), but is not limited thereto.

The image sensor module 600 has an imaging surface that forms an image with light. The image sensor module 600 may be disposed such that the imaging surface of the light is perpendicular to the direction of light incident from the folded module 400. The image sensor may generate an electrical signal for an image formed on the imaging surface. The electrical signal may be transmitted to an external circuit through a connector.

The housing 200 may accommodate the folded module 400 and may have an opening that exposes the OIS coil to the inside of the housing 200 toward the OIS magnet. Additionally, the housing 200 may have an opening that exposes the AF coil to the inside of the housing 200 toward the AF magnet.

The circuit board 300 may be disposed to surround the housing 200 from the outside. In other words, the circuit board 300 may surround at least a portion of the side portion of the housing 200. For example, the circuit board 300 may have a shape that is bent twice. The housing 200 may have a box shape with an upper part open having the bottom portion and four side portions, and in this case, the circuit board 300 that is bent twice may be disposed to surround three of the four side portions of the housing 200. The circuit board 300 may include a flexible printed circuit board (FPCB) or a rigid flexible printed circuit board (RFPCB).

At least a portion of the OIS driver and at least a portion of the AF driver may be disposed on the circuit board 300. For example, the OIS coil and the AF coil may be disposed on the circuit board 300. That is, the OIS coil and the AF coil may be disposed in the housing 200 via the circuit board 300.

The camera module 10 may provide an optical image stabilization (OIS) function. If the camera shakes unintentionally due to hand tremors or other causes when shooting, the OIS function may compensate for this. For example, the camera module 10 may provide the OIS function by driving the folded module 400 by the OIS driver.

The OIS driver may include the OIS magnet and the OIS coil. For example, the OIS magnet may be located on the folded module 400, and the OIS coil may be located on the circuit board 300. The OIS magnet and the OIS coil may be disposed to face each other, and when power is supplied to the OIS coil through the circuit board 300, the folded module 400 may rotate around the first axis parallel to the first direction (Z-axis direction) due to electromagnetic interaction between the OIS coil and the OIS magnet. The OIS magnet and the OIS coil may be disposed as a set to correspond to the lens module 100. The present disclosure is not limited thereto, and the OIS driver including the OIS magnet and the OIS coil may be disposed in a lens holder.

The camera module 10 may provide an autofocus (AF) function. The AF function may automatically focus on the subject. For example, the camera module 10 may provide the AF function by driving the lens module 100 in the optical axis direction by an autofocus (AF) driver.

The AF driver may include the AF magnet and the AF coil, the AF magnet may be located in the lens module 100, and the AF coil may be located on the circuit board 300.

The AF magnet and the AF coil may be disposed to face each other, and when power is supplied to the AF coil through the circuit board 300, the lens module 100 may move in the optical axis direction (Z-axis direction) by electromagnetic interaction between the AF coil and the AF magnet. The AF magnet and the AF coil may be disposed as a set in the lens module 100.

Referring to the light path of the camera module according to the present embodiment with reference to FIG. 5, the light incident in the first direction from the lens module 100 may be totally reflected toward the upper surface of the waveguide part 415 at the first split reflecting surfaces 411 of the optical waveguide member 410. The light that reaches the upper surface of the waveguide part 415 may be totally reflected toward the lower surface of the waveguide part 415, and the light that reaches the lower surface of the waveguide part 415 may be totally reflected again toward the upper surface of the waveguide part 415. After repeating this total internal reflection several times within the waveguide part 415, the light can reach the second split reflecting surfaces 413. The light that reaches the second split reflecting surfaces 413 may be totally reflected at the second split reflecting surfaces 413 and incident on the image sensor module 600. In FIG. 5, it is shown that total internal reflection occurs three times within the waveguide part 415, but this is for convenience of explanation, and in this embodiment, much more total internal reflection can occur within the waveguide part 415.

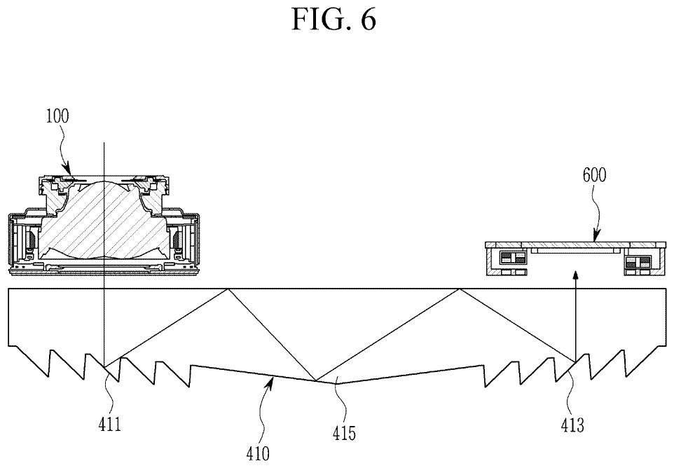

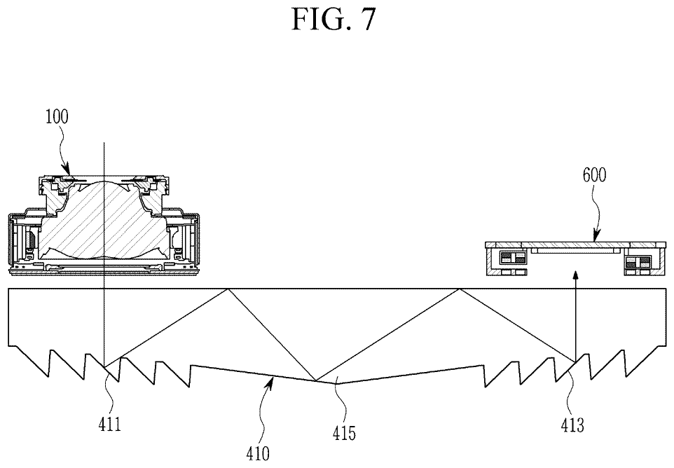

Hereinafter, camera modules according to various embodiments will be described with reference to FIGS. 6 and 7. FIGS. 6 and 7 are schematic illustrations of a camera module according to another embodiment.

The camera modules illustrated in FIGS. 6 and 7 have substantially the same configuration as the embodiments described with reference to FIGS. 1 to 3. Below, different configurations are described, and the same drawing symbols are used for the same configurations, and configurations not described separately may be configured in the same manner as the embodiments illustrated in FIGS. 1 to 3.

Referring to FIG. 6, the camera module according to the present embodiment may have an AF/OIS driver for autofocus (AF) and optical image stabilization (OIS) disposed in both the lens module 100 and the image sensor module 600. This allows for autofocus and optical image stabilization to be performed in the lens module 100, and for autofocus and optical image stabilization to be performed once more in the image sensor module 600.

Referring to FIG. 7, in the camera module according to the present embodiment, an AF driver for automatic focus may be disposed in the lens module 100, and an AF/OIS driver for automatic focus and optical image stabilization may be disposed in the image sensor module 600. Thus, automatic focus can be performed in the lens module 100, and automatic focus and optical image stabilization can be performed in the image sensor module 600.

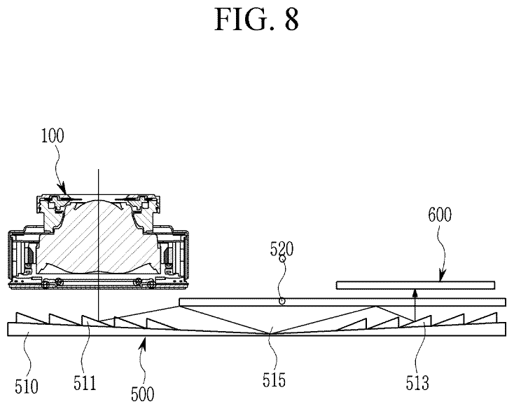

Hereinafter, a camera module according to another embodiment will be described with reference to FIG. 8. FIG. 8 is a schematic illustration of a camera module according to another embodiment.

The camera module illustrated in FIG. 8 has substantially the same configuration as the embodiments described with reference to FIGS. 1 to 3. Below, different configurations are described, and the same drawing symbols are used for the same configurations, and configurations not described separately may be configured in the same manner as the embodiments illustrated in FIGS. 1 to 3.

Referring to FIG. 8, the camera module according to the present embodiment includes a folded module with an optical waveguide module 500. The optical waveguide module 500 comprises a first mirror plate 510, a plurality of first split reflection arrays 511 disposed obliquely on one surface of the first mirror plate 510 under the lens module 100, a second mirror plate 520 disposed with a space above the first mirror plate 510, and a plurality of second split reflection arrays 513 disposed obliquely on one surface of the first mirror plate 510 under the image sensor module 600.

The first mirror plate 510 may extend from below the lens module 100 to below the image sensor module 600. The first mirror plate 510 may be made of a plate-shaped mirror.

The first split reflection arrays 511 may have multiple reflective surfaces and may be disposed at a predetermined angle with respect to the first mirror plate 510 to totally reflect light incident from the lens module 100 in the first direction.

The second mirror plate 520 may be disposed to be spaced upward from the first mirror plate 510 to form an optical waveguide 515 between them. The second mirror plate 520 may be positioned between the lens module 100 and the image sensor module 600. Therefore, the optical waveguide 515 through which light reflected from the first split reflection arrays 511 propagates in a second direction may be formed between the first mirror plate 510 and the second mirror plate 520. This embodiment is not limited to this, and the second mirror plate 520 may also extend to below the image sensor module 600.

The second split reflection arrays 513 may have multiple reflective surfaces and may be disposed at a predetermined angle with respect to the first mirror plate 510 to totally reflect the light propagated in the second direction by the optical waveguide 515 to the image sensor module 600.

The inclination angle of the first split reflection arrays 511 and the second split reflection arrays 513 may be between 5 degrees and 45 degrees. For example, the inclination angle may be between 15 degrees and 30 degrees, so that all light can be totally reflected on the reflective surface and the light reflected from the reflective surface can reach the second mirror plate 520 or the image sensor module 600. If the inclination angle of the first split reflection arrays 511 and the second split reflection arrays 513 is less than 5 degrees, the light may not be totally reflected on the reflective surface, and if it exceeds 45 degrees, the light reflected from the reflective surface may not reach the second mirror plate 520 or the image sensor module 600.

In order to achieve the thinning of the camera module, the number of reflective surfaces of the first split reflective arrays 511 and the second split reflective arrays 513 may be two or more. As the number of reflective surfaces of the first split reflective arrays 511 and the second split reflective arrays 513 increases, the thinning effect of the camera module may be enhanced. However, as the number of reflective surfaces increases, the possibility of diffraction interference due to the reflective surface grid also increases, so it may be desirable to have five or fewer to prevent this.

The image sensor module 600 may be disposed spaced apart from the lens module 100 in a direction perpendicular to the optical axis on the top of the optical waveguide module 500. Part of the image sensor module 600 may be exposed on one side of the cover 700.

The image sensor module 600 has an imaging surface that forms an image of the light reflected by the optical waveguide module 500. The image sensor module 600 may be disposed to face the optical waveguide module 500 so that the imaging surface of the light is perpendicular to the direction of light incident from the optical waveguide module 500.

In FIG. 8, it is illustrated that the AF/OIS driver for autofocus (AF) and optical image stabilization (OIS) is disposed in the lens module 100, but this embodiment is not limited to this. For example, the AF/OIS driver may be disposed in both the lens module 100 and the image sensor module 600, or it may be disposed in the image sensor module 600, or the AF driver may be disposed in the lens module 100 and the OIS driver may be disposed in the image sensor module 600.

One aspect of the embodiments provides a camera module that may achieve a thinner profile while employing a high-resolution image sensor.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module, comprising:
a lens module comprising at least one lens;
an optical waveguide member, disposed below the lens module, configured to propagate light incident from the lens module in a first direction to a second direction through total internal reflection, and reflect the light propagated in the second direction back to the first direction, the optical waveguide member comprising a plurality of first split reflective surfaces, a waveguide part, and a plurality of second split reflective surfaces; and
an image sensor module, disposed above the optical waveguide member and spaced apart from the lens module, configured to convert the light reflected in the first direction by the optical waveguide member into an electrical signal,
wherein the plurality of first split reflective surfaces is inclined to reflect light incident from the lens module in the first direction below the lens module, the waveguide part propagates the light reflected from the plurality of first split reflective surfaces in the second direction through total internal reflection, and the plurality of second split reflective surfaces is inclined to reflect the light propagated by the waveguide part in the first direction below the image sensor module.

2. The camera module of claim 1, wherein
the plurality of first split reflective surfaces is inclined such that the incident angle of light incident from the lens module in the first direction is greater than a critical angle of the optical waveguide member, and
the plurality of second split reflective surfaces is inclined such that the incident angle of the light propagated by the waveguide part is greater than the critical angle of the optical waveguide member.

3. The camera module of claim 1, wherein
the plurality of first split reflective surfaces and the plurality of second split reflective surfaces are formed to be inclined at an angle of 5 degrees or more and 45 degrees or less with respect to a plane perpendicular to the first direction.

4. The camera module of claim 3, wherein
the plurality of first split reflective surfaces and the plurality of second split reflective surfaces are formed to be inclined at an angle of 15 degrees or more and 30 degrees or less with respect to the plane perpendicular to the first direction.

5. The camera module of claim 1, wherein
the plurality of first split reflective surfaces and the plurality of second split reflective surfaces each have 2 to 5 reflective surfaces.

6. The camera module of claim 1, wherein
the plurality of first split reflective surfaces and the plurality of second split reflective surfaces comprise a metal coating layer.

7. The camera module of claim 1, wherein
the optical waveguide member is formed by a prism made of plastic or glass material.

8. The camera module of claim 1, wherein
an imaging surface of the image sensor module is disposed to face an upper surface of the optical waveguide member.

9. The camera module of claim 1, wherein
the lens module comprises an autofocus (AF)/optical image stabilization (OIS) driver which is configured to perform AF and OIS functions.

10. The camera module of claim 1, wherein
the image sensor module comprises an AF/OIS driver configured to perform autofocus and optical image stabilization functions.

11. The camera module of claim 1, wherein
the lens module comprises an AF driver configured to perform an autofocus function, and the image sensor module comprises an OIS driver configured to perform an optical image stabilization function.

12. A camera module, comprising:
a lens module comprising at least one lens;
an optical waveguide module, disposed below the lens module, configured to propagate light incident from the lens module in a first direction to a second direction through total internal reflection, and reflect the light propagated in the second direction back to the first direction; and
an image sensor module, disposed above the optical waveguide module and spaced apart from the lens module, configured to convert the light reflected in the first direction by the optical waveguide module into an electrical signal,
wherein the optical waveguide module comprises a first mirror plate, a plurality of first split reflection arrays disposed obliquely on one surface of the first mirror plate under the lens module to reflect light incident in the first direction from the lens module, a second mirror plate disposed above the first mirror plate to form an optical waveguide between the first mirror plate and the second mirror plate, and a plurality of second split reflection arrays disposed obliquely on the one surface of the first mirror plate under the image sensor so that light propagated by the optical waveguide is reflected in the first direction.

13. The camera module of claim 12, wherein
the plurality of first split reflection arrays and the plurality of second split reflection arrays are disposed to be inclined at an angle between 15 degrees and 30 degrees with respect to the first mirror plate.

14. The camera module of claim 12, wherein
the plurality of first split reflection arrays and the plurality of second split reflection arrays each have 2 to 5 reflective surfaces.

15. The camera module of claim 12, wherein
an imaging surface of the image sensor module is disposed to face the optical waveguide module.
